(19) United States
(12) Patent Application Publication
(10) Pub. No.: US 2010/0332549 A1
(43) Pub. Date: Dec. 30, 2010

(54) RECIPES FOR REBUILDING FILES

(75) Inventors: David A. Nichols, Redmond, WA (US); Catherine Claire Marshall, San Francisco, CA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/492,316

(22) Filed: Jun. 26, 2009

(51) Int. Cl. G06F 17/30

(52) U.S. Cl. 707/802; 707/803; 707/805; 707/770

(57) ABSTRACT

The subject disclosure provides a system and/or a method that facilitates generation files from base information in accordance with recipes. In one aspect, recipes can be employed in distributed storage environments such as network-based backup architectures to conserve storage resources. A build component can generate a portion of data from base information based upon a recipe. In addition, an evaluation component can analyze the recipe to identify modifications to the recipe that improve efficiency of generation by the build component or customize the generated portion of data to a particular application.

### BACKGROUND

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

In light of such advances, the amount of available electronic data grows and it becomes more important to store such data in a manageable manner that facilitates user friendly and quick data searches and retrieval. Today, a common approach is to store electronic data in one or more databases or data stores. In general, a typical data store can be referred to as an organized collection of information with data structured such that a computer program can quickly search and select desired pieces of data, for example. Commonly, data within a data store is organized via one or more tables. Such tables are arranged as an array of rows and columns.

With the advent of highly sophisticated computer software and/or hardware, new services have emerged to meet the consumer demands associate with such sophisticated computer hardware and/or software. Typically, computational services are undertaken upon a client or within a proprietary intranet. Client-side systems are employed to manage relationships between users, software applications, services, and hardware within a client machine, as well as data resident upon a respective intranet. However, in addition to client-side systems providing services, off-site systems (e.g., third party) can also provide services in order to improve data capability, integrity, reliability, versioning, security, and mitigate costs associated therewith.

In general, these services can be employed to manage relationship between users, provide software applications, enhance hardware capabilities, manage data, optimize security, etc. For example, a third party service can enable a client to store data therewith limited solely by the third party capabilities (e.g., hardware, software, etc.). In particular, the off-site or remote data storing services enable users to access data storage via the Internet or the web for data upload or download. Such off-site or remote data storage service providers can provide backup functionality and techniques including redundancy, safe-guarding, privacy, and safe-guards against losing data.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methodologies that facilitate utilization of recipes to build or re-build files. In one aspect, recipes can be employed in a distributed data storage environment such as network-based backup architectures. For instance, recipes can be employed to represent files or other data derived from base information. Accordingly, storage resources can be efficiently utilized as derived data need not be stored. Rather, instructions to construct the derived data can be stored. When data associated with a recipe is requested, the data can be constructed, on the fly, in accordance with the recipe.

In accordance with another aspect, recipes can be evaluated to identify possible modifications thereto to improve efficiency, facilitate file format migration, and/or customize a recipe to a particular application. For example, different base information can be identified and employed in connection with a recipe. In addition, an order of operations in a recipe can be changed and/or one or more operations can be skipped, replaced with more efficient functions, and the like.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an example system that builds or rebuilds files or other data based upon a recipe in accordance with various aspects.

FIG. 2 illustrates a block diagram of an example system that analyzes a recipe to infer modifications in accordance with various aspects.

FIG. 3 illustrates a block diagram of an example system that facilitates constructing files or other data from recipes in a cloud storage environment in accordance with one or more aspects.

FIG. 4 illustrates a block diagram of an example system that utilizes recipes in a distributed cloud storage environment in accordance with various aspects.

FIG. 5 illustrates a block diagram of an example system that implements hybrid cloud-based and peer-to-peer backup storage in accordance with various aspects.

FIG. 6 illustrates a block diagram of an example system that facilitates conducting a restore in a hybrid cloud-based and peer-to-peer backup architecture in accordance with various aspects.

FIG. 7 illustrates a block diagram of an example system that facilitates utilizing recipes to build files or other information in accordance with various aspects.

FIG. 8 illustrates an example methodology for inferring modifications to a recipe to build a portion of data in accordance with various aspects.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “cloud,” “peer,” “super peer,” “client,” and the like are intended to refer to a computer-related entity, either hardware, software in execution on hardware, and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

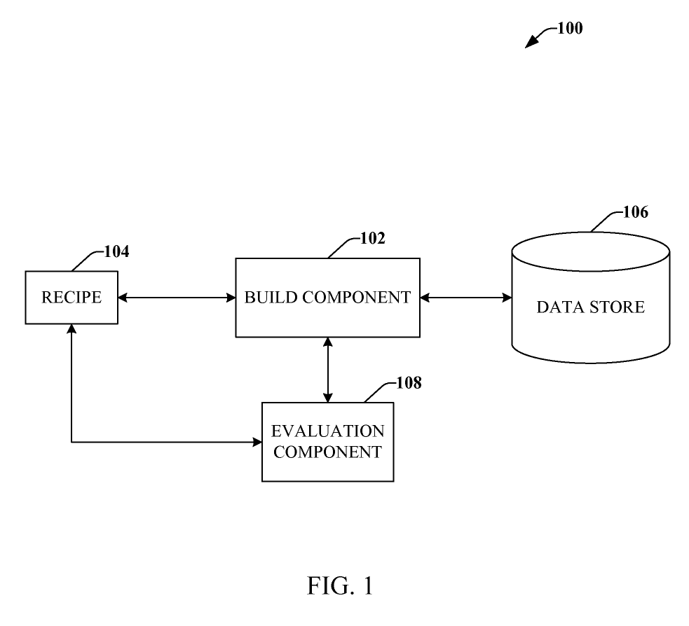

Now turning to the figures, FIG. 1 illustrates a system 100 that builds or rebuilds files or other data based upon a recipe in accordance with various aspects. In one aspect, files and/or other information can be retained as a recipe to build or construct the files. For instance, some files can be modifications, transformations, compilations, etc., of other information. Instead of storing files themselves, recipes can be stored that specify how to reconstruct files from other information. In one example, system 100 can be employed to build or rebuild files or other data based upon a recipe. For instance, a client system and/or an application on the client system that implements or is otherwise associated with system 100 can generate files on demand from recipes. System 100 includes a build component 102 that generates a file based upon a recipe 104 and portions of data. In one aspect, the portions of data can be stored in a data store 106.

The recipe 104 can include a listing of instructions, operations, and/or transformations to construct a file from other information. In one example, the recipe 104 can indicate specific codecs to apply at particular steps. In another example, the recipe 104 can specify particular features of applications to employ. For instance, the recipe 104 can include a sequence of image editing tools to utilize to on a base image recreate a modified image. It is to be appreciated that recipe 104 can be presented in any suitable language form to enable build component 102 to implement instructions specified therein.

In another aspect, recipe 104 can include content (e.g., unique content, shared content, etc.) to enable a file to be reconstructed from the included content. For instance, recipe 104 can be employed to reconstruct a file from base information (e.g., a portion of content) and a series of differentials. For example, a set of photographs can be obtained via a digital camera is quick succession. The photographs can be similar such that the photographs can be stored as a single base form (e.g., a first photograph in the set) and a series of masks that transform one photograph (e.g., the base) into a second photograph in the set. In another example, document files (e.g., word processing documents, spreadsheets, presentations, etc.) can be represented with recipe 104. For instance, an original unedited version of a document file can be a base form and a series of differentials can be included in recipe 104 to transform the document file in accordance with each edit. Accordingly, recipe 104 can include content in addition to or in place of instructions, operations, and/or transformations as described above.

The build component 102 can employ recipe 104 and other recipes (not shown) to generate a variety of file products. In one example, recipe 104 can specify a sequence of steps (e.g., instructions, transformations, operations, etc.) to modify a portion of data into a particular file. In another example, build component 102 can utilize encoding/decoding schemes specified by recipe 104 to migrate a file of one format to a file of another format. In addition, the recipe 104 can instruct the build component 102 to sample and/or combine disparate portions of data to generate a new file. For example, a video file can be generated from a recipe that instructs the build component 102 to cut and organize clips from a plurality of disparate video files.

In an aspect, the build component 102 can initiate a construction from recipe 104 transparently and/or by request from a user, application, client machine, etc. For example, a user, application, and/or client machine can request a file to be built from a recipe. In another example, the user, application and/or client machine can request access to a file absent prior knowledge as to whether the file exists or requires reconstruction from a recipe. In such example, the recipe can mimic existence of the file while internally specifying content and/or operations to build the file. For instance, the file can be generated and cached for a period of time before being removed to free storage space. In such cases, the build component 102 can implement recipe 104 and deliver the requested file. Otherwise, a cached copy of the file can be provided.

In accordance with another aspect, system 100 can include an evaluation component 108 that analyzes recipe 104. The evaluation component 104 can examine recipe 104 to infer substitutions and/or modifications to recipe 104 to improve quality of generated files and/or direct recipe 104 to implement a particular result (e.g., a special file format, etc.). According to one example, the evaluation component 108 can analyze recipe 104 and identify a portion of data as a starting point that differs from a portion of data indicated in recipe 104 to generate a particular result (e.g., a special file format, etc.) that differs from a product specified by recipe 104. In another example, the evaluation component 108 can identify operations and/or a series of operations that can be skipped and/or replaced with more efficient actions to efficiently implement recipe 104 while preserving a final product of recipe 104.

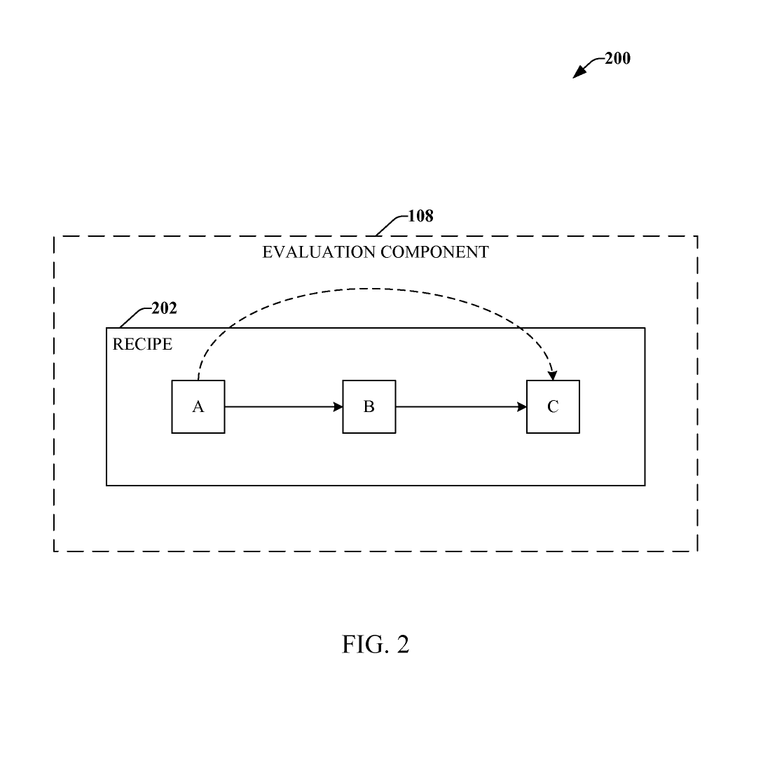

Turning briefly to FIG. 2, a system 200 is illustrated that analyzes a recipe to infer modifications in accordance with various aspects. System 200 can include the evaluation component 108 that can analyzes a recipe and infer beneficial modifications thereto. In an example depicted in FIG. 2, the evaluation component 108 can analyze recipe 202 to identify an improvement. As shown in FIG. 2, recipe 202 can include a starting portion of data, A, and a final product (e.g., a file, a portion of data, etc.), C. Based upon recipe 202, file C can be constructed, by a build component 102 for example, through an operation that transforms the portion of data A into an intermediate B. The intermediate B can be modified to generate file C. The evaluation component 108 can analyze recipe 202 and identify a transform, operation, codec, etc. that converts the starting portion of data A directly into file C without generating the intermediate B. Accordingly, in the example depicted in FIG. 2, the evaluation component 108 identifies a process improvement. The file, C, is similar to the file constructed via the original recipe 202 but a transform is replaced to construct the file more efficiently.

Turning back to FIG. 1, the evaluation component 108, after analysis, can report substitutions and/or modifications of recipe 104 to the build component 102 to be performed when generating a file prescribed by recipe 104. In another aspect, the evaluation component 108 can select a recipe capable of generating a portion of data from a plurality of recipes that generate similar data. In addition, the evaluation component 108 can create a new recipe through combination and/or synthesis of two or more recipes from a set of recipes.

In accordance with another aspect, the data store 106 can be a file system configured to operate with recipes. In one example, the file system (e.g., data store 106) can maintain base information while discarding data derived from the base information. The discarded data can be replaced with recipes that can be executed to regenerate the discarded data. The file system can maintain the discarded data in an index such that the file system appears to persist the data. The file system can employ the recipes to transparently regenerate the discarded data upon request After regeneration, the file system can persist the data for a period of time and remove the data after the period of time lapses.

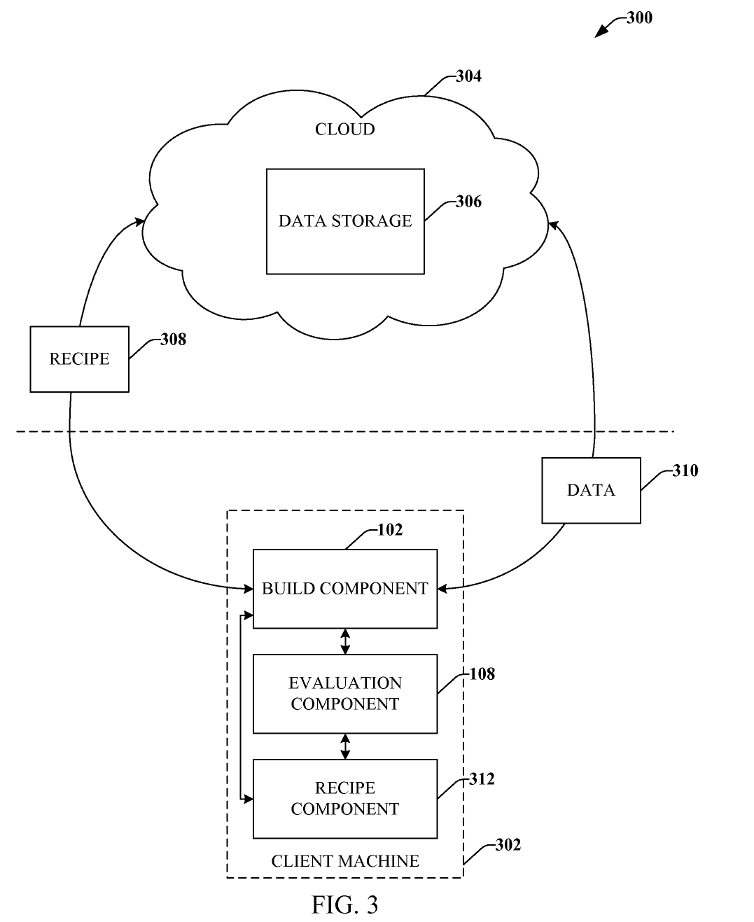

Referring to FIG. 3, illustrated is a system 300 that facilitates generation of files or other data from recipes in a cloud storage environment. System 300 can include a client machine 302 that includes a build component 102 and evaluation component 108. It is to be appreciated that the build component 102 and evaluation component 108 can be similar to and/or perform similar functions as similarly numbered components described supra with respect to previous figures. In an aspect, the client machine 302 can be a personal computer, a laptop computer, a server, a portable digital assistant (PDA), a mobile device, a smart phone, a cell phone, a portable gaming device, a media player or any other suitable computing device that can store, manipulate and/or transfer data. In one example, the build component 102, the evaluation component 108, or both components can be integrated into an operating system of client machine 302. In another example, the build component 102 and/or the evaluation component 108 can be integrated into an application executed by client machine 302. In yet another aspect, the build component 102 can be implemented as an operating system facility that provides general file construction from recipes. The evaluation component 108 can be implemented into an application to enable specialized reasoning of recipes in accordance with purposes for the application.

The system 302 can further utilize a cloud 304 that can include data storage 306 that retains data, recipes, applications, etc. It is to be appreciated that the cloud 502 can include any suitable component, device, hardware, and/or software associated with the subject innovation. The cloud 304 can refer to any collection of resources (e.g., hardware, software, combination thereof, etc.) that are maintained by a party (e.g., off-site, on-site, third party, etc.) and accessible by an identified user (not shown) over a network (e.g., Internet, wireless, LAN, cellular, Wi-Fi, WAN, etc.). The cloud 304 is intended to include any service, network service, cloud service, collection of resources, etc. and can be accessed by an identified user via a network. For instance, two or more users can access, join, and/or interact with the cloud 304 and, in turn, the data storage 306.

The cloud 304 can provide remote or online data storage or archiving of information. To enable efficient utilization of storage space, recipes can be employed. For example, data storage 306 of cloud 304 can store recipe 308 (as well as additional recipes) that can be employed by build component 102 in connection with a portion of data 310 to generate a file. Thus, cloud 304 can retain a portion of data 310 and recipes, such as recipe 308, which generate derivations of the portion of data 310 instead of storing data 310 and any derived data.

In another aspect, the client machine 302 can include a recipe component 312 that facilitates archiving data (e.g., files, system images, and/or other information) as recipes. In one example, the recipe component 312 can observe modifications to a file and record such modifications to a new recipe. For instance, the recipe component 312 can track operations, transformations, or other functions applied to a file. The recipe component 312 can cache the original file for preservation. In the alternative, the client machine can temporarily render modifications to a file in real-time while safeguarding the original. When a user saves a file or commits a file to persistent storage, the recipe component 312 can generate a recipe to build the modified file from the original.

In accordance with another example, the recipe component 312 can interact with other applications (not shown) to generate recipes. For instance, a particular application can edit files by recording a sequence of operations. The recipe component 312 can translate recorded sequences of operations from the application into a recipe format suitable for employment by the build component 102 and/or the evaluation component 108.

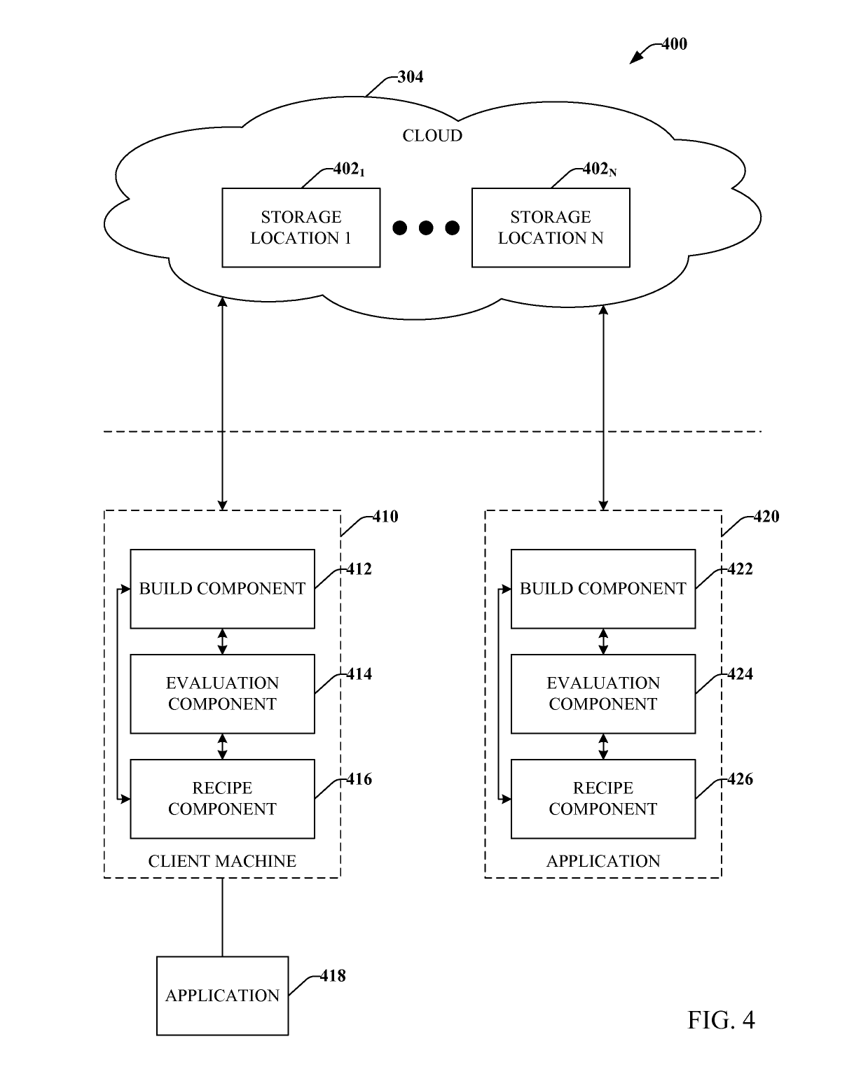

Turning now to FIG. 4, illustrated is a system 400 that utilizes recipes in a distributed cloud storage environment in accordance with various aspects. As depicted in FIG. 4, system 400 can include cloud 304 that can provide online storage services to client machines such as client machine 410 and/or applications such as application 420. In an aspect, cloud 304 can include a plurality of storage locations 402 (e.g., depicted in FIG. 4 as storage locations 402₁ through 402_{N} where N is an integer greater than or equal to one). The storage locations 402 can include client machines such as, but not limited to, personal computers, mobile devices, laptop computers, PDAs, or other suitable computing devices. In addition, the storage locations 402 can further include servers (e.g., enterprise servers, home servers, etc.), content distribution networks, and so on. Cloud 304 can include any collection of resources (e.g., hardware, software, combination thereof, etc.) that are maintained by a party (e.g., off-site, on-site, third party, etc.) and accessible by an identified user over a network (e.g., Internet, wireless, LAN, cellular, WiFi, WAN, etc.). For instance, users can access, join and/or interact with cloud 304 (e.g., via cloud backup service offered by an entity) and, in turn, store data (e.g., backup information and/or chunks thereof) at the cloud 304 which provide cheap storage with high availability.

Cloud 304 can manage locality of information retained therein. Cloud 304 can distribute portions of information among storage locations 402 such that availability and optimal locality is maintained while reducing storage costs, bandwidth costs, and latency times upon restoration. Cloud 304 can evaluate characteristics of storage locations 402 and distribute chunks of backup data accordingly. The characteristics can include availability of storage locations (e.g., based on device activity levels, powered-on or powered-off status, etc.), available storage space at locations, cost of storage at locations, cost of data transfer to/from locations, network locality of locations (e.g., network topology), and the like. In one example, cloud 304 can distribute more data to storage locations with higher storage capability and availability than to other storage locations (e.g., normal client machines).

In another aspect, system 400 can include a client machine 410 and an application 420. The client machine 410 can include a build component 412, an evaluation component 414, and a recipe component 416. Similarly, the application 420 can include a build component 422, an evaluation component 424, and a recipe component 426. It is to be appreciated that the build components 412 and 422, the evaluation components 414 and 424, and the recipe components 416 and 426 can be similar to and perform similar functions as build component 102, evaluation component 108, and recipe component 312 described herein with reference to FIGS. 1 and 3. In one example, the components 412-426 can be integrated into an operating system of the client machine 410. Other applications, such as application 418, that are internally executed on client machine 410 or external from client machine 410 can interact with the components 412-416 to utilize recipes to represent complex data, build files from recipes, and/or infer modifications to existing recipes. In another example, the components can be integrated into applications. For instance, application 420 can incorporate build component 422, evaluation component 424, and recipe component 426, to implement recipe-related functionality as described herein.

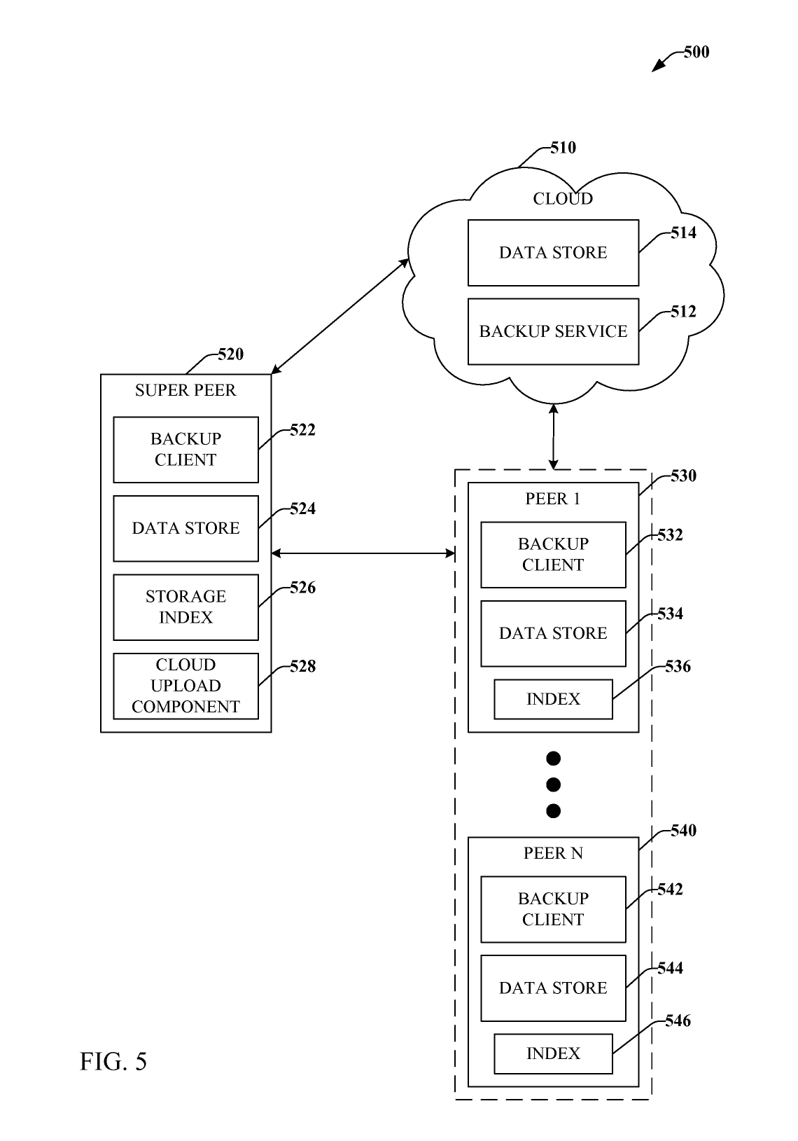

Referring next to FIG. 5, illustrated is a system 500 that implements hybrid cloud-based and peer-to-peer storage in accordance with various aspects. As system 500 illustrates, a network implementation can utilize a hybrid peer-to-peer and cloud-based structure, wherein a cloud 510 interacts with one or more super peers 520 and one or more peers 530-540.

In accordance with one aspect, cloud 510 can be utilized to remotely implement one or more computing services from a given location on a network/internetwork associated with super peer(s) 520 and/or peer(s) 530-540 (e.g., the Internet). Cloud 510 can originate from one location, or alternatively cloud 510 can be implemented as a distributed Internet-based service provider. In one example, cloud 510 can be utilized to provide backup or other storage functionality to one or more peers 520-540 associated with cloud 510. Accordingly, cloud 510 can implement a backup service 512 and/or provide associated data store 514.

In one example, data storage 514 can interact with a backup client 522 at super peer 520 and/or backup clients 532 or 542 at respective peers 530 or 540 to serve as a central storage location for data residing at the respective peer entities 520-540. In this manner, cloud 510, through data storage 514, can effectively serve as an online “safe-deposit box” for data located at peers 520-540. It can be appreciated that backup can be conducted for any suitable type(s) of information, such as files (e.g., documents, photos, audio, video, etc.), system information, and/or chunks of files or system information. Additionally or alternatively, distributed network storage can be implemented, such that super peer 520 and/or peers 530-540 are also configured to include respective data storage 524, 534, and/or 544 for backup data associated with one or more machines on the associated local network. In another example, techniques such as de-duplication, incremental storage, and/or other suitable techniques can be utilized to reduce the amount of storage space required by data storage 514, 524, 534, and/or 544 at one or more corresponding entities in the network represented in FIG. 5 for implementing a cloud-based backup service.

In accordance with another aspect, cloud 510 can interact with one or more peer machines 520, 530, and/or 540. As illustrated in FIG. 5, one or more peers 520 can be designated as a super peer and can serve as a liaison between cloud 510 and one or more other peers 530-540 in an associated local network. While not illustrated in FIG. 5, it should be appreciated that any suitable peer 530 and/or 540, as well as designated super peer(s) 520, can directly interact with cloud 510 as deemed appropriate. Thus, it can be appreciated that cloud 510, super peer(s) 520, and/or peers 530 or 540 can communicate with each other at any suitable time to synchronize files or other information between the respective entities associated with system 500.

In one example, super peer 520 can be a central entity on a network associated with peers 520-540, such as an enterprise server, a home server, and/or any other suitable computing device(s) determined to have the capability for acting as a super peer in the manners described herein. In addition to standard peer functionality, super peer(s) 520 can be responsible for collecting, distributing, and/or indexing data among peers 520-540 in the local network. For example, super peer 520 can maintain a storage index 526, which can include the identities of respective files and/or file segments corresponding to peers 520-540 as well as pointer(s) to respective location(s) in the network and/or in cloud data storage 514 where the files or segments thereof can be found. In another aspect, peers 530 and 540 can include respective indexes 536 and 546 which can include local cache of at least a portion of storage index 526. Although shown in FIG. 5 to be associated with super-peer 520, it is to be appreciated that the storage index 526 can be managed by cloud 510, peers 530-540, and/or distributed among super peer 520, cloud 510 and peers 530-540. Additionally or alternatively, super peer 520 can act as a gateway between other peers 530-540 and a cloud service provider 510 by, for example, uploading respective data to the cloud service provider 510 at designated off-peak periods via a cloud upload component 528. However, peers 530-540 can communicate information directly to cloud service provider 510.

It is to be appreciated that the data stores illustrated in system 500 (e.g., data stores 514, 524, 534, and 544) can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store of the subject systems and methods is intended to comprise, without being limited to, these and any other suitable types of memory. In addition, it is to be appreciated that the data stores can be a server, a database, a hard drive, a pen drive, an external hard drive, a portable hard drive, and the like.

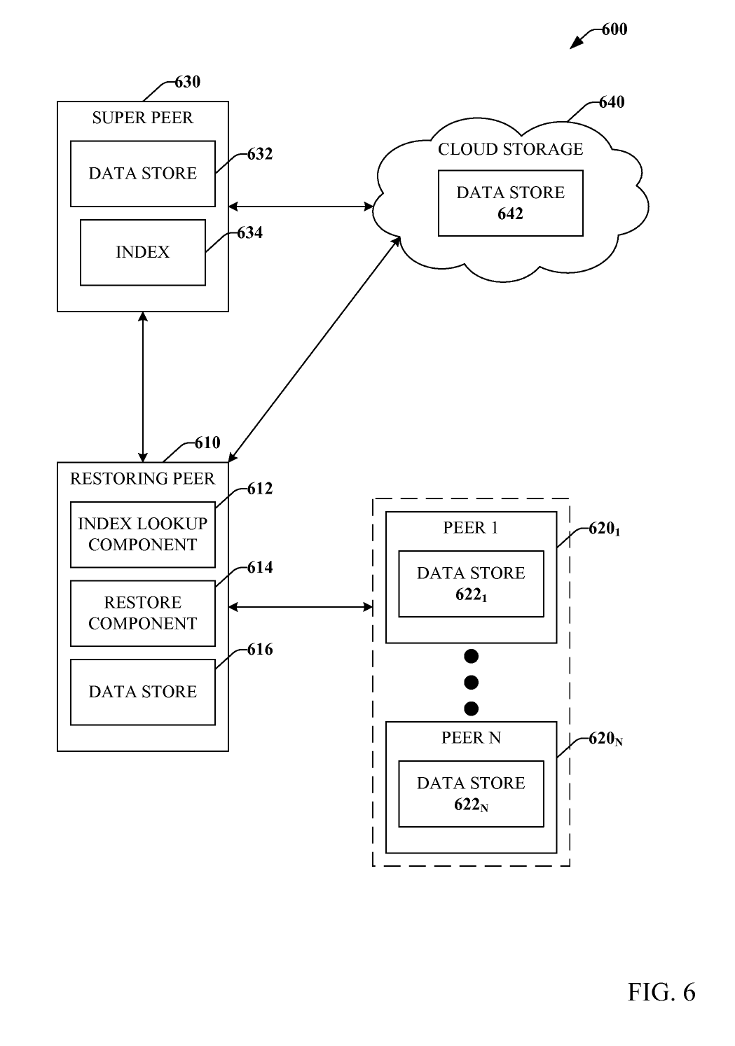

Referring now to FIG. 6, illustrated is a system 600 that facilitates conducting a differential restore in a hybrid cloud-based and peer-to-peer backup architecture in accordance with various aspects. As system 600 illustrates, a hybrid P2P/cloud backup architecture can be utilized, wherein backup information corresponding to one or more computing devices is distributed among one or more peers machines 610 or 620 and/or one or more super-peer machines 630, as well as one or more cloud storage locations 640.

In one example, peer machines 620 can include respective data stores 622, which can be utilized to receive and maintain backup information corresponding to one or more files, system images, or other information. Backup information stored in data stores 622 can be associated with, for example, a restoring peer 610. The backup information can include chunks of files or other data generated by the restoring peer 610 (or another device) via remote differential compression, for example. In addition, the restoring peer 610 can additionally or alternatively include a data store 616 for locally storing backup information (or chunks thereof) corresponding to files, versions of files, system images, and the like, residing locally at restoring peer 610.

In another example, one or more super peers 630 in system 600 can additionally include a data store 632 as well as an index 634, which can provide a master listing of blocks of backup information stored within system 600 and their respective locations. Although index 634 is illustrated as located at super peer 630 in system 600, it should be appreciated that some or all of index 634 could additionally or alternatively be located at one or more peers 610 and/or 620 as well as at cloud storage 640.

In accordance with one aspect, the restoring peer 610 can include a restore component 614 that can issue a restore request. The restore request can be a request to roll-back a version of file retained by the restoring peer 610 with a previous version distributed in system 600. In another example, the restore request can be a command to recover a version (e.g., a most recent version, an original version and/or any version therebetween). An index lookup component 612 can obtain metadata from index 634 and/or any other suitable source that points to the respective locations of file versions to be restored.

Based on the locations obtained by index lookup component 612, the restore component 614 can pull blocks of backup information from their corresponding locations within data store(s) 622, 632, 642, and/or any other suitable storage location within system 600. Accordingly, in one example, a restore can be conducted by pulling incremental delta chunks necessary to recreate a desired version. In another example, a complete rendition of the desired version can be located and obtained.

In accordance with another example, the hybrid P2P/cloud backup architecture of system 600 can be exploited to minimize latency and/or bandwidth required to restore one or more file versions at a restoring peer 610. For example, restore component 614 can analyze system 600 to facilitate pulling of respective blocks from the path of least resistance through system 600. Thus, for example, in the event that a given block resides at data store 622 or 632 at a peer 620 or super peer 630 as well as in cloud storage 640, preference can be given to pulling the block from the nearest network nodes first. As a result, a peer 620 and/or super peer 630 can be prioritized over cloud storage 640 to minimize the latency and bandwidth usage associated with communicating with cloud storage 640. In addition, restore component 614 can analyze availability of respective nodes in system 600, relative network loading and/or other factors to facilitate intelligent selection of nodes from which to obtain file versions. Accordingly, the restoring peer 610 can be configured to first attempt to obtain blocks from a peer machine 620 or a super peer 630, falling back on cloud storage 640 only if no peers 620 and/or 630 with required file versions are available. In an alternative example, super peer 630 and/or another entity from which the restoring peer 610 accesses index 634 can utilize similar network analysis in order to select an optimal location from among a plurality of locations that retains a block as indicated by the index 634. Once selected, such location(s) can be subsequently provided to a restoring peer 610.

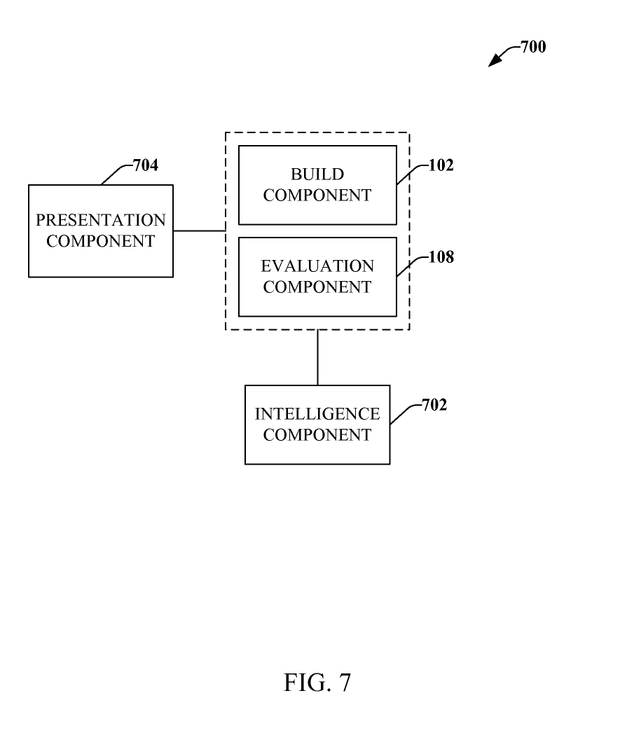

FIG. 7 illustrates a system 700 that facilitates utilizing recipes to build files or other information in accordance with various aspects. The system 700 can include the build component 102 and the evaluation component 108, which can be substantially similar to respective components, boxes, systems and interfaces described in previous figures. The system 700 further includes an intelligence component 702. The intelligence component 702 can be utilized by the build component 102 or the evaluation component 108 to infer, for example, substitutions in a recipe, modifications to the recipe, and the like.

The intelligence component 702 can employ value of information (VOI) computation in order to implement and/or modify recipes. For instance, by utilizing VOI computation, the most ideal and/or appropriate recipes, the most ideal base information, or the most appropriate transform improvements can be determined. Moreover, it is to be understood that the intelligence component 702 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The build component 102 and evaluation component 108 can further utilize a presentation component 704 that provides various types of user interfaces to facilitate interaction between a user and any component coupled to system 700. As depicted, the presentation component 704 is a separate entity that can be utilized with the build component 102 and evaluation component 108. However, it is to be appreciated that the presentation component 704 and/or similar view components can be incorporated into the build component 102 and evaluation component 108/or a stand-alone unit. The presentation component 704 can provide one or more graphical user interfaces (GUIs), command line interfaces, and the like. For example, a GUI can be rendered that provides a user with a region or means to load, import, read, edit etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

The user can also interact with the regions to select and provide information via various devices such as a mouse, a roller ball, a touchpad, a keypad, a keyboard, a touch screen, a pen and/or voice activated mechanism, a body motion detection mechanism, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

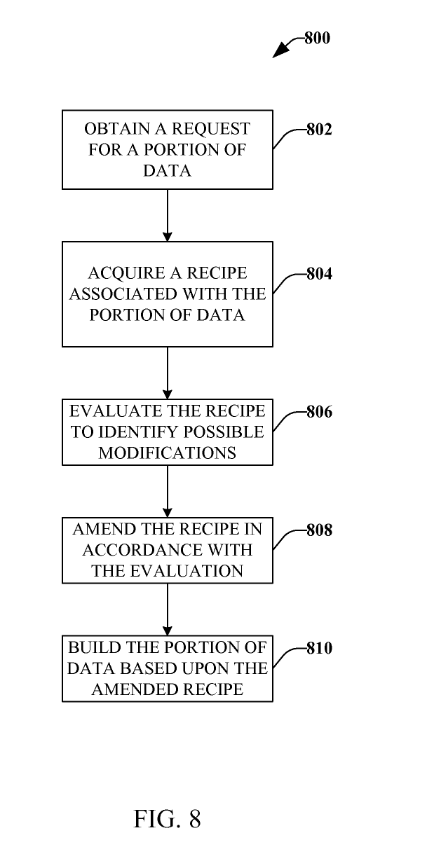

FIG. 8 illustrates a methodology and/or flow diagram in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 8, a method 800 for inferring modifications to a recipe to build a portion of data is illustrated. At reference numeral 802, a request for a portion of data can be obtained. The request can originate from a client machine, an application on the client machine, an operating system on the client machine and the like. At reference numeral 804, a recipe associated with the portion of data is acquired. In one aspect, the portion of data requested can be derived from base information. To conserve storage space, a recipe to construct the portion of data from base information can be persisted in place of the portion of data.

At reference numeral 806, the recipe can be evaluated to identify possible modifications. In one example, the recipe can be analyzed to infer substitutions and/or modifications that improve quality of generated data and/or direct the recipe to implement a specific result (e.g., a special file format). For instance, disparate base information can be identified. In addition, operations and/or a series of operations that can be skipped can be identified. Further, operations specified in the recipe can be identified as obsolete in view of more efficient actions.

At reference numeral 806, the recipe is amended in accordance with the evaluation. For instance, operations can be resequenced, skipped, and/or replaced. At reference numeral 810, the portion of data can be built based upon the amended recipe.

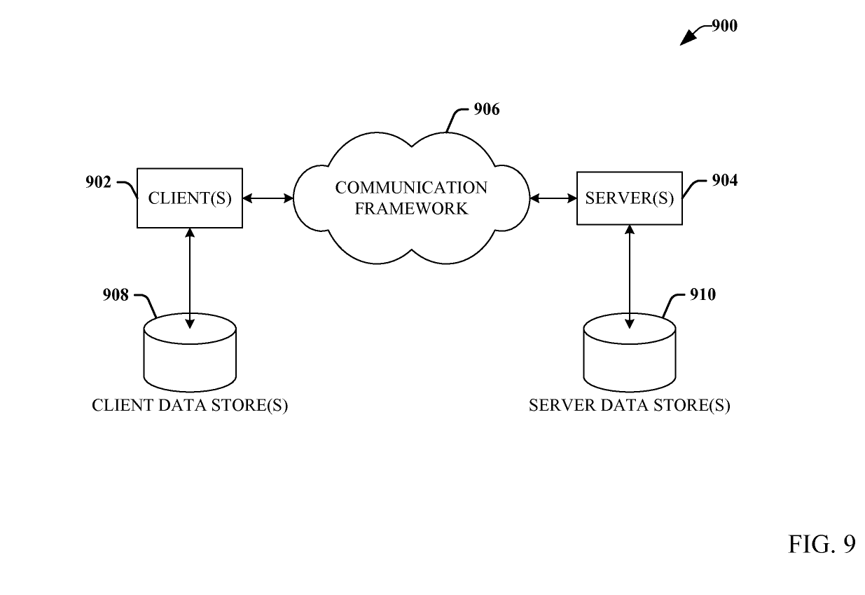

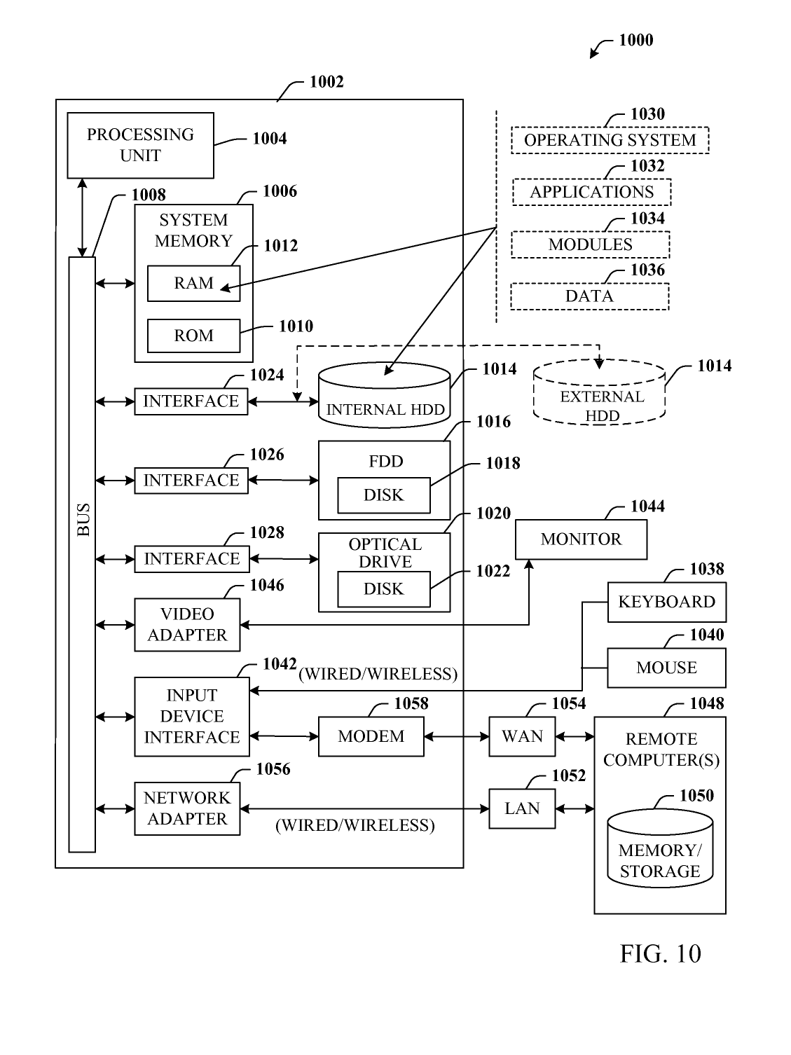

In order to provide additional context for implementing various aspects of the claimed subject matter, FIGS. 9-10 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Generally, program modules include routines, programs, components, data structures, etc., that perform particular tasks or implement particular abstract data types. Moreover, those skilled in the art will appreciate that the claimed subject matter can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Referring now to FIG. 9, there is illustrated a schematic block diagram of an exemplary computer compilation system operable to execute the disclosed architecture. The system 900 includes one or more client(s) 902. The client(s) 902 can be hardware and/or software (e.g., threads, processes, computing devices). In one example, the client(s) 902 can house cookie(s) and/or associated contextual information by employing one or more features described herein.

The system 900 also includes one or more server(s) 904. The server(s) 904 can also be hardware and/or software (e.g., threads, processes, computing devices). In one example, the servers 904 can house threads to perform transformations by employing one or more features described herein. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

With reference to FIG. 10, an exemplary environment 1000 for implementing various aspects described herein includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1394 interface technologies. Other external drive connection technologies are within contemplation of the subject disclosure.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11 (a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 13 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates construction of information from recipes, comprising:
a processor coupled to a memory that retains computer-executable instructions, the processor executes:
a build component that generates a portion of data from base information based upon a recipe; and
an evaluation component that analyzes the recipe to identify modifications to the recipe that at least one of improve efficiency of generation by the build component or customize the generated portion of data to a particular application.

2. The system of claim 1, wherein the recipe includes a listing of at least one of instructions, operations, or transformations.

3. The system of claim 2, wherein the build component executes the listing included in the recipe to convert base information into the portion of data.

4. The system of claim 1, wherein the base information includes a plurality of disparate files.

5. The system of claim 1, wherein the evaluation component identifies substitute base information from base information specified in the recipe.

6. The system of claim 1, wherein the evaluation component identifies a one substitute operation to at least one function included in the recipe.

7. The system of claim 6, wherein the substitute operation alters a format of the portion of data generated by the build component.

8. The system of claim 6, wherein the substitute operation replaces the at least one function in the recipe.

9. The system of claim 8, wherein the replaced at least one function is obsolete relative to the substitute operation.

10. The system of claim 1, wherein the build component generates the portion of data in accordance with recipe modifications identified by the evaluation component.

11. The system of claim 1, further comprising a recipe component that facilitates archiving information as recipes.

12. The system of claim 11, wherein the recipe component observes modifications to a portion of information and records observed modifications in the recipe.

13. The system of claim 1, wherein the build component and the evaluation component are incorporated into a distributed storage environment that includes a set of storage locations.

14. The system of claim 13, wherein the set of storage locations include one or more of peers or cloud storage locations.

15. The system of claim 1, wherein the evaluation component selects the recipe from a plurality of recipes that generate the portion of data from base information.

16. The system of claim 1, wherein the evaluation component generates a new recipe through a combination of two or more recipes.

17. A method for employing recipes to generates files stored in a file system, comprising:
employing a processor executing computer-executable instructions stored on a computer-readable storage medium to implement the following acts:
generating a recipe associated with a file stored in the file system, the file is derived from base information, the recipe can be employed to regenerate the file from base information;
discarding the file while persisting the recipe associated with the file; and
employing the recipe to regenerate the file in response to a request to the file system for the file.

18. The method of claim 17, wherein the recipe includes a listing of at least one of instructions, operations, or transformations, the listing of instructions are executed to convert the base information into the file.

19. The method of claim 17, further comprising persisting the file regenerated via the recipe for a period time and discarding the file after the period of time lapses.

20. A system that facilitates generation of data from recipes, comprising:
at least one processor that executes computer-executable code stored in memory to effect the following:
means for obtaining a request to access a portion of information;
means for acquiring a recipe associated with the portion of information;
means for analyzing the recipe to discover optimizations;
means for amending the recipe to include discovered optimizations; and
means for constructing the portion of information from base data in accordance with the amended recipe.
